(19) United States
(12) Patent Application Publication
(10) Pub. No.: US 2008/0089565 A1
(43) Pub. Date: Apr. 17, 2008

(54) Pattern Matching

(76) Inventor: Kui Ming Chui, Middlesex (GB)

Correspondence Address: DAVIS BUJOLD & Daniels, P.L.L.C., 112 PLEASANT STREET, CONCORD, NH, 03301, US

(21) Appl. No.: 11/665,283

(22) PCT Filed: Oct. 17, 2005
(86) PCT No.: PCT/GB05/03986

§ 371 Date: Apr. 13, 2007

(30) Foreign Application Priority Data
Oct. 15, 2004 (GB) 0422930.8

(51) Int. Cl. G06K 9/00

(52) U.S. Cl. 382/125

(57) ABSTRACT

Matching of a scanned fingerprint (F) with a reference, master pattern involves running-filter de-convolution (10) of image edge-response functions (ERF) of the scanned pattern to determine from the mid-point of the full-width-half-maximum (FWHM) of the derived line spread function (LSF) the true location (11) in the image domain of the respective edge. The true-edge locations (X1-X5, Y1-Y5) are linked to one another according to the sense with which density/intensity changes (L-H/H-L) in orthogonal scan-sweeps (X, Y). Merging of the linked edges produces a skeleton representation of the scanned pattern that is used for initial comparison with a reference skeleton (21-24) of the master. If the skeletons match, a density/intensity comparison is made with the master after reconstructing the subject-pattern image using sub-pixel transfer (31) across the identified edges. The method is applicable to matching facial and other anatomical features in real time or otherwise, and to one dimensional pattern-matching as used for eye-iris, bar-code and DNA recognition.

This application is a national stage of PCT/GB2005/003986 filed Oct. 17, 2005 which claims priority from British Application Serial No. 0422930.8 filed Oct. 15, 2004.

### FIELD OF THE INVENTION

This invention relates to methods and systems for pattern matching.

### SUMMARY OF THE INVENTION

According to one aspect of the present invention there is provided a method for pattern matching wherein image edge-response functions of a scanned pattern are each submitted to a de-convolution process to determine from the mid-point of the full-width-half-maximum of the derived line spread function the true location in the image domain of the respective edge, and the true-edge locations are linked to one another with reference to the sense with which density or intensity of the scanned pattern changes in the scan-sweep through them so as to derive a skeleton representation of the scanned pattern, and wherein the skeleton representation is utilised in a matching comparison with a reference or master pattern.

According to another aspect of the invention there is provided a system for pattern matching including means for submitting each image edge-response function of a scanned pattern to a de-convolution process for determining from the mid-point of the full-width-half-maximum of the derived line spread function the true location in the image domain of the respective edge, and means for linking the true-edge locations to one another with reference to the sense with which density or intensity of the scanned pattern changes in the scan-sweep through them so as to derive a skeleton representation of the scanned pattern, and wherein the skeleton representation is utilised in a matching comparison with a reference or master pattern.

The de-convolution process may be carried out by least-squares running filtering, and the linking of true-edge locations to one another may be carried out as between mutually-adjacent true-edge locations according to whether the spacing between them does not exceed a certain maximum and the sense with which density or intensity of the scanned pattern changes in the scan-sweep through them is the same.

The matching comparison may comprise comparison for matching between the skeleton representation of the scanned pattern and a skeleton representation, which may be a stored representation, correspondingly derived from the reference or master pattern. Furthermore, the matching comparison may alternatively or also include comparison for matching between a density pattern derived from the skeleton representation of the scanned pattern and a reference or master density pattern.

The scanned pattern may be a one- or two-dimensional pattern, and in the latter respect may be a fingerprint or other anatomical feature for matching with a record of that feature.

### BRIEF DESCRIPTION OF THE DRAWINGS

A method and system according to the present invention will now be described, by way of example with reference to the accompanying drawings, in which:

FIG. 1 is a schematic representation of the pattern-matching system according to the invention;

FIG. 2 is illustrative of a de-convolution process carried out on an edge-response function of a scanned pattern in the system of FIG. 1; and

FIGS. 3 to 5 are illustrative of further processing carried out in the system of FIG. 1.

### DETAILED DESCRIPTION OF THE INVENTION

The method and system of the invention are for application generally in pattern matching, but will be described with reference to the drawings in specific application to fingerprint recognition, and in particular to the taking and matching of a person's fingerprint with a digitally-stored record of an earlier-taken, “master” fingerprint. In this respect, the method and system have application not only in the context of criminal investigation and other forensic purposes, but more generally in person-identification and confirmation as used for security purposes in regard, for example, to the use of cash-dispenser machines, mobile telephones, computers and area-access systems. Nonetheless, the method and system of the invention are to be understood to be applicable more widely than to fingerprint recognition, in that they may be applied to the recognition and matching of facial or other anatomical features of a person or animal, whether sensed in real time (for example via a video camera) or otherwise (for example from a photograph).

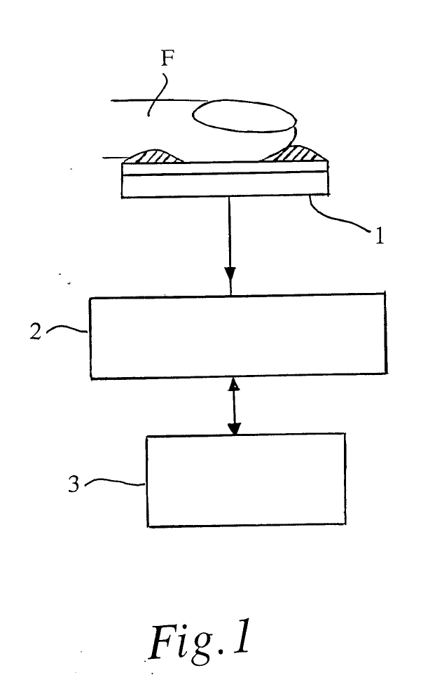

Referring to FIG. 1, the fingerprint matching method and system utilises a fingerprint sensor 1 which scans the presented finger F two dimensionally to produce signals representative of the pattern of the fingerprint. This pattern involves contoured areas of high intensity or density corresponding to the ridges of the fingerprint, with intervening spaces of low intensity or density; the attributes of high and low intensity or density, may be reversed according to the form of sensing used.

A data-processing unit 2 responds to the signals from the sensor 1 to derive effectively an image of a limited region of the pattern for use as a scan matrix within which the definition of the contour-edges between high and low density of the pattern are greatly enhanced. The enhanced result is compared for matching with data representative of “master” fingerprint records stored in a store 3.

The “master” records are of fingerprints previously obtained from persons that are to be identified for fingerprint matching by the method and system. Although these records are obtained using the same processing for enhancement as that utilised in producing the representation for which matching is being sought, they cover a much larger area of the fingerprint than that used for the latter representation. This allows for the possibility that when matching is being sought, the finger F is not located in exactly the same register within the sensor 1 as it was previously for production of the “master” record, and requires a searching process to be carried out by the processing unit 2 when checking the existence or otherwise of a match.

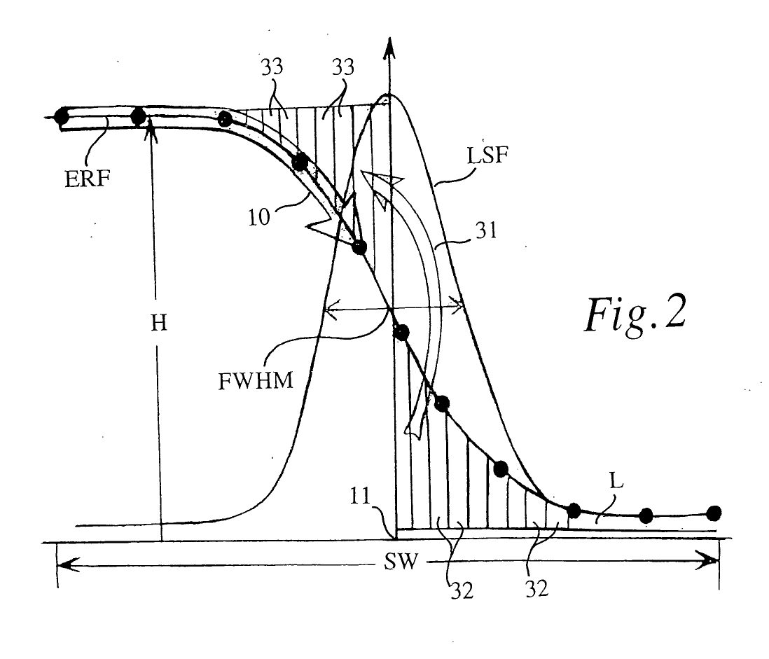

The processing carried out by the unit 2 involves a de-convolution process applied to the image-representation of the fingerprint pattern within the two-dimensional scan matrix. The de-convolution process is performed using a least-squares running filter that sweeps the image-representation in both X- and Y-axis directions of the scan matrix with sub-pixel sampling of at least three times that used for the pattern scan within the sensor 1. Each edge between high and low density within the fingerprint-pattern gives rise, as illustrated in FIG. 2, to an edge-response function ERF, and this on de-convolution using a five-point-fit running filter as represented by arrow 10, traces out a line-spread function LSF overlying the ERF. In order to extract the maximum spatial resolution in the diagonal direction of the scan-matrix to a single pixel modulation, a minimum sampling interval or frequency of three-times the sub-pixel sampling rate is required.

The true location of the contour-edge represented by the ERF, within the spatial window width SW of the scan is identified by the scan-location 11 of the mid-point of the full-width-half-maximum FWHM of the derived LSF. The spatial window width SW chosen will be several times that of the FWHM, and will need to be varied where compensation for depth of field in the object-scan is required. Furthermore, provision may be made for removing spurious line spread functions caused by overshoots or noise-spikes, by filtering them out on the basis of their low magnitude compared with the other line spread functions within the same region of the spatial window width SW.

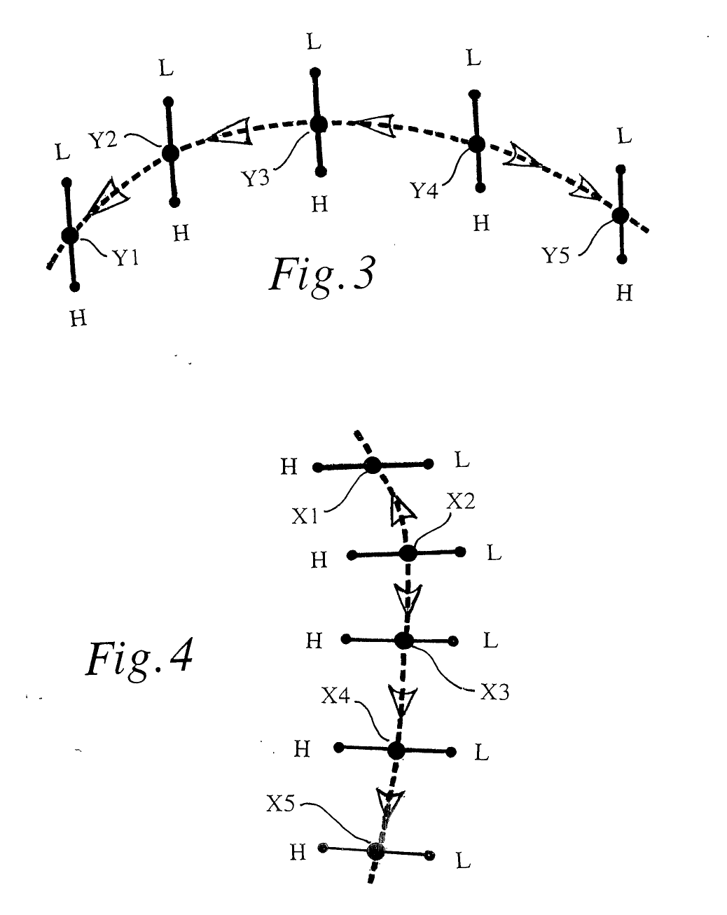

The mid-point 11 of the FWHM of each derived LSF in the X- and Y-scans of the scan matrix identifies the true location where a contour-edge is crossed by that respective scan. A situation in which, for example, five crossing points in the Y-scan are identified is illustrated in FIG. 3 by points Y1-Y5. Points X1-X5 in FIG. 4 correspondingly illustrate five crossing-points identified in the X-scan. Although the points Y1-Y5 and X1-X5 give pin-point locations of contour-edges of the fingerprint pattern, they do not in themselves define those edges unambiguously since they do not all necessarily relate to the same contour edge. This ambiguity is resolved to enable appropriate linking of the crossing points by use of a density-flag algorithm that attributes to each point the sense with which there is change from high density to low density or vice versa, in the scan. Accordingly, a contrast-density sense is attributed to each individual contour-edge identified in the X- and Y-scans. This is illustrated in FIG. 3 where successive sweeps of the Y-scan (each made in the direction from top to bottom of the illustration) are shown to pass through the true edge-crossings at points Y1-Y5, in the sense from low intensity L to high intensity H. Similarly, in FIG. 4, successive sweeps of the X-scan (each made in the direction from left to right of the illustration) are shown to pass through the true edge-crossings at the points X1-X5 in the sense from high intensity H to low intensity L.

Having attributed a contrast-density or intensity sense to each identified true-edge location of the X- and Y-scans, the identified contour-crossing points of the respective scan are linked appropriately with one another to provide a partial-skeleton outline of the fingerprint contouring. To this end, the algorithm makes an arbitrary selection of one of the identified locations and uses this as a “seed” location from which others of the identified locations that relate to the same edge-contour are progressively determined for linking up to one another. When no other identified location of the scan can be linked within this “family”, the process is repeated with selection of another “seed” from the remaining identified locations and determination of a family of locations for link-up in reproduction of a second edge-contour. The process is then repeated until all edge-contours represented in partial-skeleton form by the individual edge-crossing points of the X- and Y-sweeps of the scan matrix, have been reproduced.

The criteria used in the density-flag algorithm for determining family membership will now be described in the context of the identified points Y1-Y5 of FIG. 3. In this, it will be assumed that point Y4 is selected as the seed from which the process starts.

Referring to FIG. 3, the linking of point Y4 to point Y5 can proceed provided the spacing between them does not exceed a certain maximum (for example about 2.8 pixel) and the contrast-density sense (low density L to high density H in this illustration) is the same. The spacing criterion establishes that points Y4 and Y5 are close enough to be adjacent locations on the same contour-edge as one another, and the sense criterion confirms this. If the contrast-sense of the point Y5 were to be different from that of the point Y4, the two could not be on the same contour-edge. Accordingly, by using the criteria of spacing and sense the linking of point Y4 to point Y5 is valid.

The criteria of spacing and sense are similarly used between points Y4 and Y3 to establish that they can be validly linked. From this the criteria are used again as between points Y3 and Y2 to establish that they too can be linked, and then between points Y2 and Y1 to complete the valid linking of all five location-points Y1-Y5 as belonging to the same family as one another in definition of an individual contour-edge.

The flag-density algorithm is applied with the same criteria of spacing and sense to the identified locations of the X-scan. In this respect and as illustrated in the example of FIG. 4, for which the point X2 is assumed to be the selected seed, the distance between point X2 and each of points X1 and X3, and between the points X3 and X4 and between the points X4 and X5 meet the spacing criterion. Furthermore, since the sense of each point X1-X10, is high density H to low density L, the sense criterion is satisfied to authenticate their linking together.

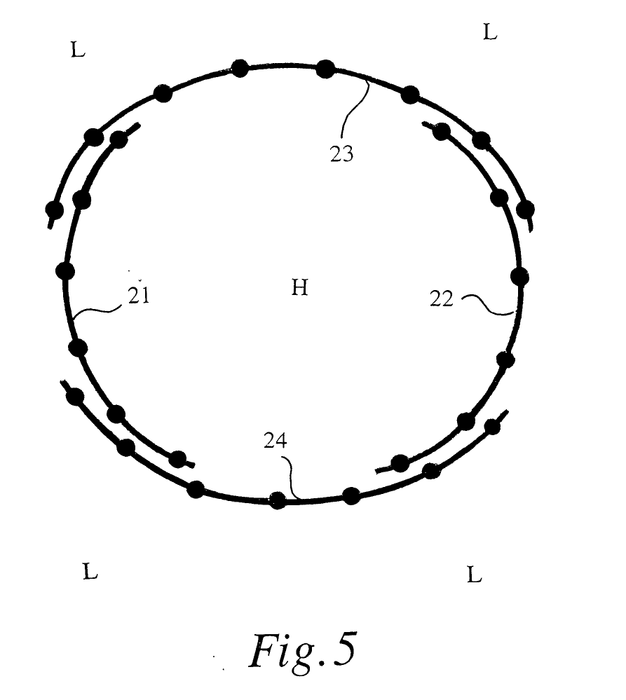

Having established partial skeletons from the X- and Y-scans, they are merged together in a manner illustrated in FIG. 5 where two sectors 21 and 22 of edge-contour derived from the X-scan and two sectors 23 and 24 from the Y-scan are illustrated. Provided, as in this illustration, the contrast-density or intensity senses of the two sectors 21 and 22 match with one another and with those of the sectors 23 and 24, their merger gives the edge-contour or -contours between high- and low-density within the fingerprint pattern, to pixel-accuracy.

Where, as illustrated in FIG. 5, there is not complete linking up between the X- and Y-scan sectors in the merger, they are joined up where the gap between them is less than one pixel. Accordingly, in the case illustrated in FIG. 5 there will be combining of the sectors 21 to 24 where their ends overlap one another at less than one pixel spacing, to establish, in this example, a closed-loop contour.

The contour-skeleton defined by the merger of the partial skeletons from the X- and Y-scans of the scan matrix is used as a primary or initial matching check with the stored “master” record. The stored “master” record comprises the contour-skeleton of the fingerprint, but this covers a significantly-larger area than the skeleton-contour derived during operation of the method and system for checking for a match. Thus, the initial recognition check involves a search of the stored “master” contour-skeleton to find a part having matching correspondence to the operationally-derived contour-skeleton. Once this correspondence is found, a second, full recognition check is carried out.

The second, full recognition check is carried out after enlargement to sub-pixel level of the operationally-derived contour-skeleton. This enlargement is achieved using linear interpolation or dynamic filtering, and is followed by exercise of a back-projection algorithm. The back-projection algorithm attributes appropriate contrast-density, or intensity, weightings to sub-pixels either side of the contour, and transfers those on the lower contrast-density side, in reverse order to the higher contrast-density side, so as effectively to re-construct the density pattern of the fingerprint within the scan matrix.

This is illustrated in FIG. 2 by the arrow 31 which represents transfer of sub-pixels 32 on the lower contrast-density side L of the contour-edge (defined by the point 11) in reverse order to the higher contrast-density side H. The sub-pixels 32 transferred are added as correspondingly-weighted sub-pixels 33 to the higher-contrast side H for effective restoration within image space of the clear-cut density contrast at the relevant contour-edge.

However, magnification enlarging the contour-skeleton may not be necessary for the degree of matching required, in which case the application of linear interpolation or dynamic filtering for sub-pixel generation, can be omitted. The density pattern can then be produced either directly, or using the back-projection algorithm, from the data used for compiling the contour-skeleton.

The density pattern however produced is compared with a “master” density pattern for the same part of the fingerprint identified in the first recognition check based on the skeleton contour. This “master” density pattern is either a part of the larger area of the stored record, or is generated specially for the second recognition check from the stored “master” skeleton contour. The comparison with it is carried out by effectively superimposing the two density patterns on one another and using, for example, the difference-map technique to establish the existence or otherwise of the required degree of matching.

Although the method and system of the invention are described above in the context of matching two-dimensional patterns, they may also be used for matching one dimensional patterns. The pattern of the iris of the eye used for identification in the context of identity cards and other security measures, the pattern used for DNA representation, and the bar-code pattern itself, are examples of one-dimensional patterns to which the matching method and system of the invention may be applied.

1.-22. (canceled)

23. A method for pattern matching with a reference pattern, the method comprising the steps of submitting image edge-response functions of a scanned pattern to a de-convolution process to determine, from a mid-point of a full-width-half-maximum of the derived line spread function, true-edge locations in an image domain of the respective edge, and
linking the true-edge locations to one another with reference to a sense with which one of density and intensity of the scanned pattern changes in a scan-sweep through them so as to derive a skeleton representation of the scanned pattern, and
utilizing the skeleton representation in a matching comparison with the reference pattern.

24. The method according to claim 23, further comprising the step of carrying out the de-convolution process by least-squares running filtering.

25. The method according to claim 23, further comprising the step of carrying out the linking of true-edge locations to one another as between mutually-adjacent true-edge locations according to whether spacing between them does not exceed a certain maximum and a sense with which one of density and intensity of the scanned pattern changes in the scan-sweep through them is the same.

26. The method according to claim 23, wherein the matching comparison comprises the step of comparing between the skeleton representation of the scanned pattern and a skeleton representation correspondingly derived from the reference pattern.

27. The method according to claim 26, further comprising the step of using a stored representation as the correspondingly-derived skeleton representation.

28. The method according to claim 23, wherein the matching comparison comprises the step of comparing between a density pattern derived from the skeleton representation of the scanned pattern and a reference density pattern.

29. The method according to claim 28, further comprising the step of using a stored pattern as the reference density pattern.

30. The method according to claim 28, further comprising the step of deriving the reference density pattern from a stored skeleton representation of the reference pattern.

31. The method according to claim 28, further comprising the step of deriving the density pattern from the skeleton representation of the scanned pattern by transfer of sub-pixels within the image-domain profile of each image edge-response function from one side to the other of the true-edge location to enhance a spatial resolution thereof.

32. The method according to claim 23, further comprising the step of scanning the scanned pattern in two orthogonal directions, the true-edge locations for each direction of scan are linked to one another as aforesaid, and the linked-together true-edge locations for the two sweeps of scan are merged with one another to derive the skeleton representation of the scanned pattern.

33. A method of fingerprint matching with a reference pattern, the method comprising the steps of submitting image edge-response functions of a scanned fingerprint pattern to a de-convolution process to determine, from a mid-point of a full-width-half-maximum of the derived line spread function, true-edge locations in the image domain of the respective edge, and lining the true-edge locations to one another with reference to the sense with which one of density and intensity of the scanned fingerprint pattern changes in a scan-sweep through them so as to derive a skeleton representation of the scanned fingerprint pattern, and utilizing the skeleton representation of the scanned fingerprint pattern in a matching comparison with the reference pattern.

34. A system for pattern matching with a reference pattern, the system comprising:
means for submitting each image edge-response function of a scanned pattern to a de-convolution process for determining, from a mid-point of a full-width-half-maximum of the derived line spread function, a true-edge location in the image domain of the respective edge, means for linking the true-edge locations to one another with reference to the sense with which one of density and intensity of the scanned pattern changes in the scan-sweep through them, for deriving a skeleton representation of the scanned pattern, and means for matching comparison of the skeleton representation with the reference pattern.

35. The system according to claim 34, wherein the de-convolution process is carried out by least-squares running filtering.

36. The system according to claim 34, wherein the linking of true-edge locations to one another is carried out as between mutually-adjacent true-edge locations according to whether the spacing between them does not exceed a certain maximum and the sense with which one of density and intensity of the scanned pattern changes in the scan-sweep through them is the same.

37. The system according to claim 34, wherein the matching comparison comprises comparison for matching between the skeleton representation of the scanned pattern and a skeleton representation correspondingly derived from the reference pattern.

38. The system according to claim 37, wherein the correspondingly-derived skeleton representation is a stored representation.

39. The system according to claim 34, wherein the matching comparison includes comparison for matching between a density pattern derived from the skeleton representation of the scanned pattern and a reference density pattern.

40. The system according to claim 39, wherein the reference density pattern is a stored pattern.

41. The system according to claim 39, wherein the reference density pattern is derived from a stored skeleton representation of the reference pattern.

42. The system according to claim 39, wherein the density pattern derived from the skeleton representation of the scanned pattern is derived by transfer of sub-pixels within the image-domain profile of each image edge-response function from one side to the other of the true-edge location to enhance its spatial resolution.

43. The system according to claim 34, wherein the scanned pattern is scanned in two orthogonal directions, the true-edge locations for each direction of scan are linked to one another as aforesaid, and the linked-together true-edge locations for the two sweeps of scan are merged with one another to derive the skeleton representation of the scanned pattern.

44. A system for fingerprint matching with a reference pattern, the system comprising means for submitting each image edge-response function of a scanned fingerprint pattern to a de-convolution process for determining from mid-point of a full-width-half-maximum of the derived line spread function a true-edge location in the image domain of the respective edge, means for linking the true-edge locations to one another with reference to the sense with which one of density and intensity of the scanned fingerprint pattern changes in the scan-sweep through them, for deriving a skeleton representation of the scanned fingerprint pattern, and means for matching comparison of the skeleton representation with the reference pattern.
